(19) United States
(12) Patent Application Publication
(10) Pub. No.: US 2007/0189560 A1
(43) Pub. Date: Aug. 16, 2007

(54) Sound generator module, sound generating structure, and electronic device utilizing the same

(76) Inventors: Hiroaki Uenishi, Gunma (JP); Fumihisa Ito, Gunma (JP); Yukihiro Matsui, Gunma (JP); Hisayoshi Matsui, Takasaki-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/642,481

(22) Filed: Dec. 20, 2006

(30) Foreign Application Priority Data
Dec. 28, 2005 (JP) 2005-380506

(51) Int. Cl. H04R 25/00

(52) U.S. Cl. 381/191; 381/190

(57) ABSTRACT

A piezoelectric sound generator module is provided which has a reduced thickness and superior mountability while ensuring good sound pressure characteristics. A sound generating structure and an electronic device, each utilizing the sound generator module, are also provided. The sound generator module has a structure in which a holding member and an acoustic space forming member are bonded to each other while a piezoelectric vibration plate including piezoelectric elements bonded to front and back sides of a vibration plate is held between both the members. A window allowing the piezoelectric vibration plate to vibrate without interference and a lead-out portion are formed in the holding member. An acoustic space, a lead-out portion, and a sound guide path are formed in the acoustic space forming member. By bonding the piezoelectric vibration plate and the acoustic space forming member to the holding member, a thin sound generator module including the sound guide path in itself is formed. The sound generator module is mounted inside a housing having a sound output hole formed in its side surface.

### BACKGROUND OF THE INVENTION

1. Field of the Invention

The present invention relates to a sound generator module, a sound generating structure, and an electronic device, the latter two utilizing the sound generator module. More specifically, the present invention relates to a reduction in thickness and an improvement in mountability of the module.

2. Description of the Related Technology

Known examples of acoustic conversion electronic components used in cellular phones include the dynamic type utilizing electromagnetic induction and the piezoelectric type utilizing a piezoelectric phenomenon. Among them, the dynamic-type acoustic conversion electronic component comprises, for example, a vibration plate made of a resin such as PET (polyethylene terephthalate), a coil as a driving source, a magnet surrounding the coil, and a case or a cover made of a metal such as stainless steel. Hence it has a complicated structure and a larger number of parts. Further, the dynamic-type acoustic conversion electronic component must have a certain thickness due to the presence of the coil, and it cannot be said as being suitable for a thickness reduction.

On the other hand, the piezoelectric-type acoustic conversion electronic component employs a piezoelectric vibration plate for conversion to sounds, and a case or a cover as a structure for supporting the piezoelectric vibration plate. In a piezoelectric vibration plate (piezoelectric sound generator) such as a piezoelectric speaker, for example, a piezoelectric element is bonded to at least one principal surface of the vibration plate, and the edge of the vibration plate is attached to the case or the cover. The vibration plate is formed of a metal plate made of, e.g., stainless steel or a resin plate made of, e.g., PET. The piezoelectric element is made of a piezoelectric ceramic such as PZT (piezoelectric (lead) zirconate titanate). The case or the cover is made of a metal such as stainless steel, or a resin such as PPS. The case or the cover is also employed to form an acoustic space for the piezoelectric sound generator. In some examples, only a double-faced tape ring is employed to not only fix the piezoelectric vibration plate, but also to form the acoustic space without employing the case or the cover.

Japanese Unexamined Patent Application Publication Nos. 2002-223497 and 2003-158794, for example, disclose piezoelectric acoustic devices each of which is supported by a stepped portion formed in a frame or a case.

The above-described piezoelectric sound generators are generally mounted in housings of electronic devices. More specifically, the piezoelectric sound generator is bonded to an inner surface of the housing of the electronic device so as to provide a structure in which sounds are produced through a hole (sound output hole) formed in an inner housing of the piezoelectric sound generator. Examples of such mounting are described in a piezoelectric sound producer of Japanese Unexamined Patent Application Publication No. 10-150697 and in a portable communication terminal of Japanese Unexamined Patent Application Publication No. 2002-77346.

Further, in order to effectively use a mount space, it is proposed to bond a piezoelectric sound generator to another electronic component (e.g., a liquid crystal display) (see, e.g., Japanese Unexamined Patent Application Publication No. 2005-117201), or to mount a module, which is constituted by an electronic component containing a piezoelectric sound generator therein, within a housing of an electronic device, thus providing a structure in which sounds are produced through a sound output hole formed in the housing.

### SUMMARY OF CERTAIN INVENTIVE ASPECTS

Each of the above-described piezoelectric sound generators has a simple structure and a small number of parts and is able to reduce weight. In addition, a thickness reduction can also be realized if the amplitude of the piezoelectric vibration plate is ensured. However, those piezoelectric sound generators have disadvantages as follows. With the construction in which the stepped portion is formed in the case or the frame, as disclosed in Japanese Unexamined Patent Application Publication Nos. 2002-223497 and 2003-158794, the case itself has a certain thickness and a substantial reduction in thickness cannot be realized. Also, a mold, etc. are required to form the case. When the piezoelectric sound generator is mounted inside the housing of the electronic device as disclosed in Japanese Unexamined Patent Application Publication Nos. 10-150697 and 2002-77346, an acoustic space has to be set on the housing side. Further, in order to introduce sounds laterally of the piezoelectric sound generator, a passage for guiding the sounds to the housing has to be set separately.

When the piezoelectric sound generator is bonded to another electronic component as disclosed in Japanese Unexamined Patent Application Publication No. 2005-117201, it is required to adjust an acoustic space and to separately provide a structure for guiding sounds to the front side. Further, when the module constituted by the electronic component containing the piezoelectric sound generator therein is mounted within the housing of the electronic device, it is also required to previously set an acoustic space in the module. Therefore, if the acoustic space is previously set on the piezoelectric sound generator side, such an arrangement is advantageous from the viewpoints of ensuring good sound pressure characteristics, realizing a thickness reduction, and improving mountability.

In view of the above-mentioned state of the art, one object of t certain inventive aspects is to provide a piezoelectric sound generator module which has a reduced thickness and superior mountability while ensuring good sound pressure characteristics. Another object is to provide a sound generating structure and an electronic device each of which utilizes the sound generator module.

To achieve the above objects, the sound generator module according to certain inventive aspects comprises a piezoelectric vibration plate including a piezoelectric element on a principal surface of a vibration plate; a holding member holding the piezoelectric vibration plate; and an acoustic space forming member forming an acoustic space for the piezoelectric element, wherein the holding member and the acoustic space forming member are bonded to each other.

According to one of primary aspects of the present invention, the acoustic space forming member includes at least one sound guide path in continuity with the acoustic space. According to another aspect, assuming a width of the sound guide path to be W and a diameter of the piezoelectric vibration plate to be φ, the relationship of (½)φ≦W≦φ is satisfied. According to still another aspect, assuming a thickness of the acoustic space forming member to be t, the relationship of 0.2 mm≦t≦4.0 mm is satisfied.

Certain inventive aspects have features as follows: (1) the holding member and the acoustic space forming member are made of the same material; (2) at least one of the holding member and the acoustic space forming member is a resin film; (3) the resin film is made of PET; and (4) at least one of the holding member and the acoustic space forming member is a yielding film. According to still another aspect, a plurality of piezoelectric vibration plates are arranged corresponding to a pair of the holding member and the acoustic space forming member.

The sound generating structure according to inventive aspect is a sound generating structure utilizing the sound generator module according to any one of Claims 1 to 9, wherein a sound output hole is formed in a housing to which is directly or indirectly mounted the sound generator module.

One inventive aspect relates to an electronic device including the sound generator module or the sound generating structure described above. The foregoing and other objects, features, and advantages of certain inventive aspects will be apparent from the following detailed description and the attached drawings.

According to certain inventive aspects, since the holding member for holding the piezoelectric vibration plate and the acoustic space forming member for forming the acoustic space for the piezoelectric vibration plate are each in the form of a film and the sound generator module is constituted by bonding those members to each other, a production process can be facilitated and the thickness of the sound generator module can be reduced. Also, since the sound generator module includes the acoustic space in itself, good sound pressure characteristics can be ensured and mountability can be improved.

### BRIEF DESCRIPTION OF THE DRAWINGS

FIGS. 1A-1C show a first embodiment of the present invention in which; FIG. 1A is an exploded perspective view of a sound generator module, FIG. 1B is a sectional view taken along the line #A-#A in FIG. 1A and viewed in the direction of arrows, and FIG. 1C is a sectional view showing one example of mounting of the sound generator module.

FIGS. 2A and 2B show a piezoelectric element in the sound generator module of the first embodiment in which; FIG. 2A is an exploded perspective view showing one example of a laminated structure, and FIG. 2B is a sectional perspective view showing another piezoelectric element.

FIG. 3 is a graph showing the relationship between frequency and sound pressure when the width of a sound guide path is changed in the first embodiment.

FIG. 4 is a graph showing the relationship between the width of the sound guide path and the difference between average sound pressure and sound pressure at resonance frequency within a practical band in the first embodiment.

FIGS. 5A and 5B are each a graph showing sound pressure versus frequency characteristics in examples that the thickness of a front air chamber of the sound generator module is changed in the first embodiment.

FIG. 6 is a graph showing the relationship between the thickness of the front air chamber of the sound generator module and the sound pressure difference between average sound pressure and sound pressure at resonance frequency within the practical band in the first embodiment.

FIGS. 7A and 7B show a second embodiment of the present invention in which; FIG. 7A is an exploded perspective view of a sound generator module, and FIG. 7B is a sectional view taken along the line #B-#B in FIG. 7A and viewed in the direction of arrows.

FIGS. 8A and 8B show a third embodiment of the present invention in which; FIG. 8A is an exploded perspective view of a sound generator module, and FIG. 8B is a sectional view showing one example of mounting of the sound generator module.

FIGS. 9A and 9B show a fourth embodiment of the present invention in which; FIG. 9A is an exploded perspective view of a sound generator module, and FIG. 9B is a sectional view showing one example of mounting of the sound generator module.

FIGS. 10A and 10B show a fifth embodiment of the present invention in which; FIG. 10A is an exploded perspective view of a sound generator module, FIG. 10B is a sectional view showing one example of mounting of the sound generator module, and FIG. 10C is a sectional view showing one example of mounting of a modified sound generator module.

FIGS. 11A-11C are plan views showing the sound generator modules of the first and sixth embodiments of the present invention.

### DETAILED DESCRIPTION OF CERTAIN ILLUSTRATIVE EMBODIMENTS

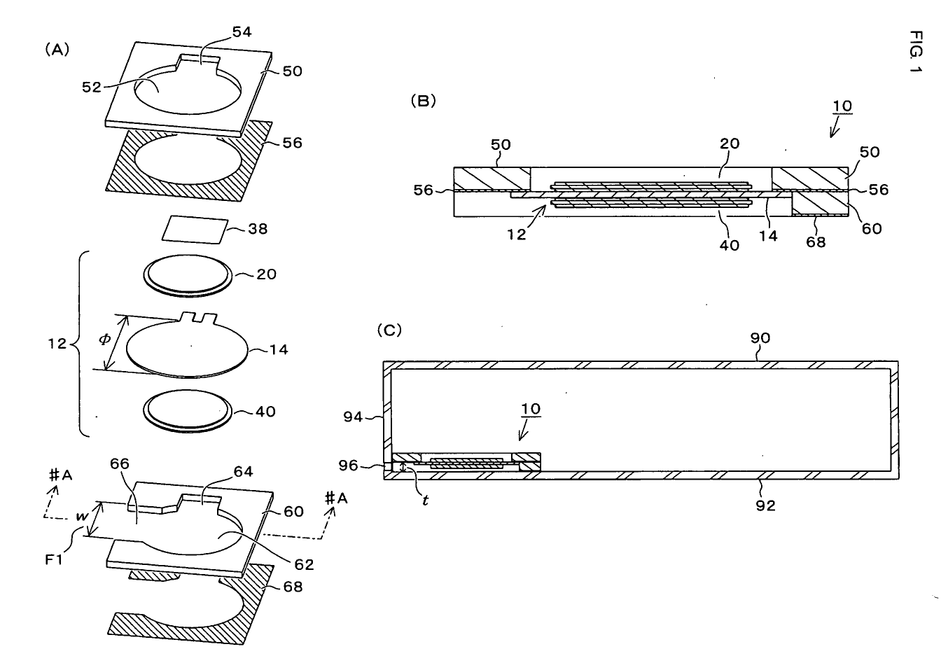

A first embodiment of the present invention will be described below with reference to FIGS. 1-6. First, a basic construction of this embodiment is described with reference to FIGS. 1A-1C. FIG. 1A is an exploded perspective view of a sound generator module, FIG. 1B is a sectional view taken along the line #A-#A in FIG. 1A and viewed in the direction of arrows, the view showing the sound generator module in an assembled state, and FIG. 1C is a sectional view showing one example of mounting of the sound generator module. As shown in FIG. 1C, a sound generator module 10 of this embodiment is mounted inside a housing 90 of an electronic device.

As shown in FIGS. 1A and 1B, the sound generator module 10 has a structure in which a piezoelectric vibration plate 12, a film-like holding member 50, and a film-like acoustic space forming member 60 which are laminated successively. The piezoelectric vibration plate 12 has a bimorph structure in which piezoelectric elements 20 and 40 are bonded to the front and back sides of a substantially circular vibration plate 14 made of a metal, e.g., stainless steel, or a resin material, e.g., PET (polyethylene terephthalate).

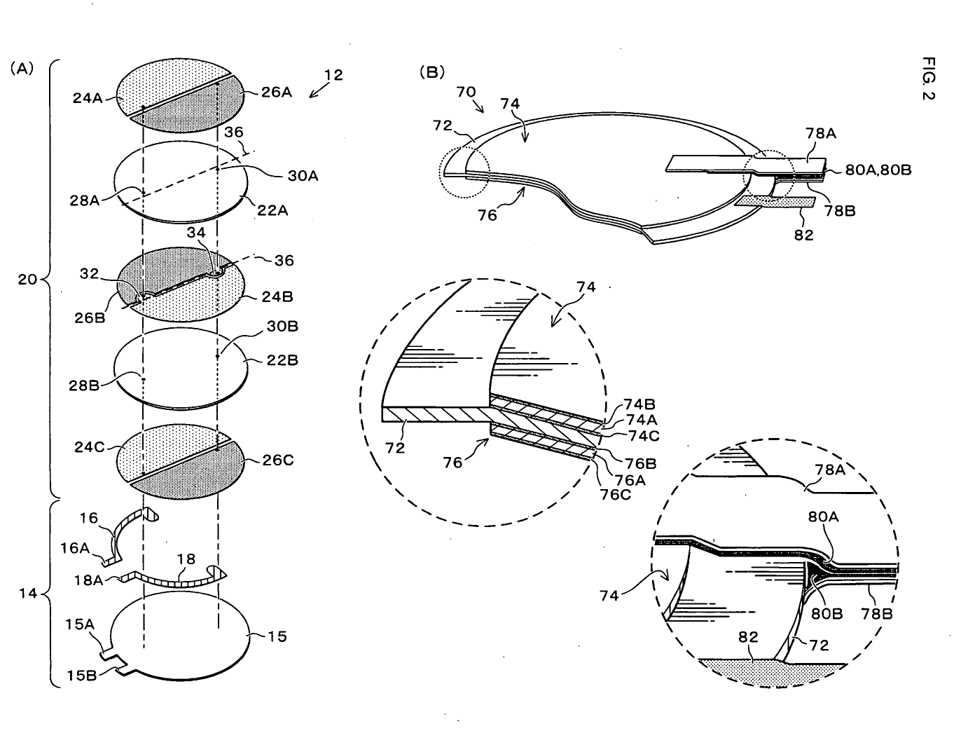

FIG. 2A shows one example of the laminated structure of the piezoelectric vibration plate 12. The vibration plate 14 is constituted by forming a pair of conductor patterns 16 and 18 with a paste of silver, copper or carbon, for example, on one principal surface of an insulating sheet 15 which is made of an insulating material with superior bendability, e.g., an insulating film such as PET. The insulating sheet 15 has a pair of lugs 15A and 15B projecting in the radial direction.

The piezoelectric element 20 has a structure in which piezoelectric layers 22A and 22B each made of a piezoelectric ceramic, e.g., PZT, and electrode layers 24A-24C and 26A-26C are alternately laminated such that the electrode layers are opposed to each other with the piezoelectric layers sandwiched between the electrode layers. Conductive layers made of, e.g., Ag or an Ag/Pd alloy, are employed as the electrode layers 24A-24C and 26A-26C. More specifically, a pair of electrode layers 24A and 26A supplied with signal voltages having different polarities are formed on one principal surface (upper surface as viewed in FIG. 2A) of the first piezoelectric layer 22A having a substantially circular shape such that the electrode layers 24A and 26A are located in respective areas dividing the principal surface of the piezoelectric layer 22A into two substantially equal parts with a gap left therebetween. A pair of electrode layers 24B and 26B and pair of electrode layers 24C and 26C, each pair being supplied with signal voltages having different polarities, are formed on opposite principal surfaces of the second piezoelectric layer 22B, respectively. Those electrode layers 24B, 26B, 24C and 26C are also each substantially semicircular in shape on each side of a division line 36 passing nearly the center of the piezoelectric layer 22B. Further, those electrode layers are arranged such that the signal voltages applied to the electrode layers 24A, 24B and 24C have the same polarity, and the signal voltages applied to the electrode layers 26A, 26B and 26C have the same polarity. In other words, the signal voltages having different polarities are applied to the electrode layers opposed to each other with the piezoelectric layer interposed between them.

Through-holes 28A and 30A are formed in the piezoelectric layer 22A, and through-holes 28B and 30B are formed in the piezoelectric layer 22B. On the other hand, at the adjacently opposed edges of the second electrode layers 24B and 26B, projections 32 and 34 are each formed to project into the semicircular area on the other side beyond the division line 36. Incidentally, the through-holes 28A, 30A, 28B and 30B are formed at positions deviated from the division line 36. Thus, the electrode layers 24A-24C are almost linearly electrically connected to each other in the direction of thickness with the provision of the through-holes 28A and 28B and the projection 32 such that the electrode layers 24A-24C are all held at a common potential. Also, the electrode layers 26A-26C are almost linearly electrically connected to each other in the direction of thickness with the provision of the through-holes 30A and 30B and the projection 34 such that the electrode layers 26A-26C are all held at a common potential. Further, by using a conductive adhesive (not shown), the electrode layer 24C is bonded to and contacted with one conductor pattern 16 formed on one principal surface of the insulating plate 15, and the electrode layer 26C is bonded to and contacted with the other conductor pattern 18 thereon. Though not shown, the piezoelectric element 40 having the same structure as the piezoelectric element 20 is disposed on the other principal surface of the insulating plate 15, and the piezoelectric layers 20 and 40 are electrically conductible to each other between the front and back sides of the vibration plate 14.

In the piezoelectric vibration plate 12 thus constructed, electrodes are led out by lead wires (not shown) from lead-out portions 16A and 18A of the conductor patterns 16 and 18, which serve as lead-out electrodes, through an electrical connecting portion 38, shown in FIG. 1A, for connection to a power supply (not shown). The piezoelectric vibration plate 12 can be driven by applying the signal voltages, for example, such that a positive voltage is applied to the conductor pattern 16 and a negative voltage is applied to the conductor pattern 18. Stated another way, since electrodes can be led out from the surface of the vibration plate 14, to which is bonded the piezoelectric element 20, without leading out the electrodes from the surface of the piezoelectric element 20, it is possible to reduce the thickness of an electrode leading-out region. Note that the structure of the piezoelectric vibration plate 12 and the structure for leading out the electrodes are described above, by way of example, and they may be appropriately modified as required.

The holding member 50 for holding the thus-constructed piezoelectric vibration plate 12 will be described below. The holding member 50 is in the form of a film and, in this embodiment, it is formed of a resin film made of, e.g., PET. A substantially circular window 52 is formed nearly at the center of the holding member 50 so as not to prevent vibration of the piezoelectric vibration plate 12, and a lead-out portion 54 is formed at a position corresponding to the electrode lead-out portion of the piezoelectric vibration plate 12 in a continuous relation to the window 52. The diameter of the window 52 is set to be smaller than that of the vibration plate 14 of the piezoelectric vibration plate 12, but larger than that of the piezoelectric element 20. The window 52 and the lead-out portion 54 are formed, for example, by punching the resin film. An adhesive tape 56 having adhesive layers on both sides is attached to the back surface of the holding member 50, thus enabling the piezoelectric vibration plate 12 and the acoustic space forming member 60 to be bonded to the holding member 50. The thickness of the holding member 50 is set to be larger than that of the piezoelectric element 20 such that, when the piezoelectric vibration plate 12 is bonded, the surface of the piezoelectric element 20 will not project out through the window 52.

The acoustic space forming member 60 forming the laminated structure together with the holding member 50 is in the form of a film and, in this embodiment, it is made of the same material as the holding member 50. A substantially circular acoustic space 62 is formed nearly at the center of the acoustic space forming member 60. Further, a lead-out portion 64 in continuity with the acoustic space 62 and a sound guide path 66 for guiding generated sounds to the exterior are formed in the acoustic space forming member 60. The diameter of the acoustic space 62 is substantially the same as that of the vibration plate 14 of the piezoelectric vibration plate 12 and is larger than that of the piezoelectric element 40. The sound guide path 66 is extended to reach the edge of the acoustic space forming member 60. Although the lead-out portion 64 and the sound guide path 66 are formed to extend in substantially orthogonal directions in the illustrated example, the sound guide path 66 may be formed at any position so long as it reaches the edge of the acoustic space forming member 60. The acoustic space 62, the lead-out portion 64, and the sound guide path 66 are formed, for example, by punching a resin film. As in the holding member 50, an adhesive tape 68 having adhesive layers on both sides is attached to the back surface of the acoustic space forming member 60.

The procedures for mounting the sound generator module of this embodiment will be described below. The piezoelectric elements 20 and 40 are bonded to the front and back sides of the vibration plate 14, thereby forming the piezoelectric vibration plate 12. The piezoelectric vibration plate 12 is bonded to the back surface of the holding member 50 by the adhesive tape 56. Then, the acoustic space forming member 60 is also bonded to the back surface of the holding member 50 by the adhesive tape 56. The electrodes led out from the upper surface of the vibration plate 14 are connected to, e.g., lead wires (not shown) in the electrical connecting portion 38. The sound generator module 10 thus constituted is attached to a principal surface 92 of the housing 90 of the electric device on the inner side, as shown in FIG. 1C, by the adhesive tape 68 on the back side of the acoustic space forming member 60. In a side surface 94 of the housing 90, a sound output hole 96 is previously formed at a position corresponding to the sound guide path 66 so that sounds generated from the piezoelectric vibration plate 12 are transmitted to the exterior through the acoustic space 62, the sound guide path 66, and the sound output hole 96.

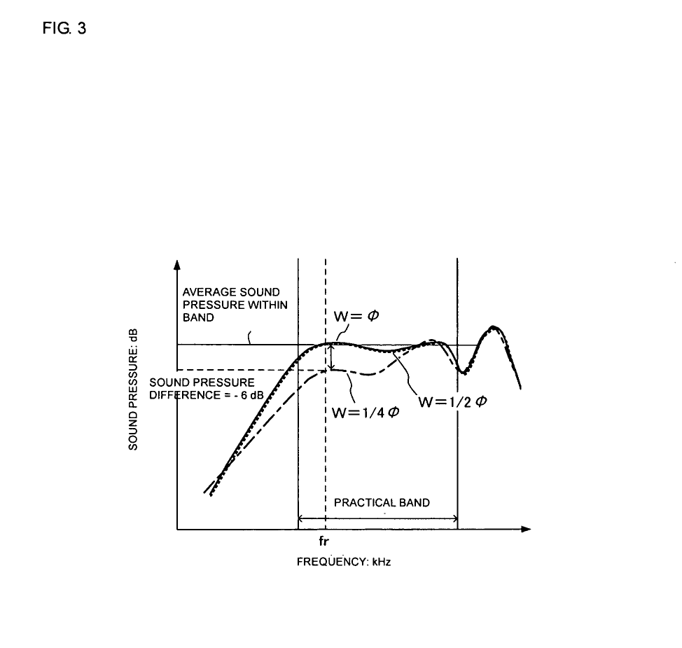

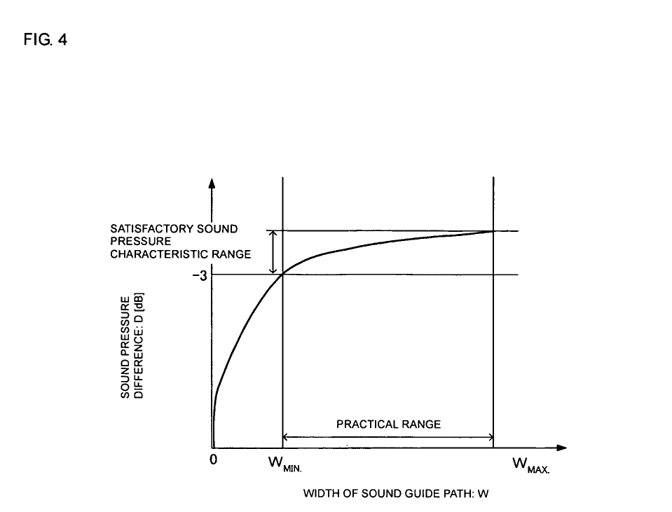

The width of the sound output hole 66 will be described below with reference to FIGS. 3 and 4. FIG. 3 is a graph showing the relationship between frequency and sound pressure when the width of the sound guide path is changed in this embodiment, and FIG. 4 is a graph showing the relationship between the width of the sound guide path and the difference between average sound pressure and sound pressure at resonance frequency within a practical band. The term “width of the sound guide path” used herein means the sound guide path width in a direction substantially perpendicular to the direction in which the generated sounds are guided, and the term “diameter of the piezoelectric vibration plate 12” means the effective diameter except for a portion of the piezoelectric vibration plate 12 which is supported by the holding member 50. Sound pressure characteristics of the sound generator module 10 of this embodiment depend on the width of the sound guide path 66. Assuming the width of the sound guide path 66 to be W and the diameter of the piezoelectric vibration plate 12 to be φ as shown in FIG. 1A, in the case of 0 mm<W<(½)φ, the sounds generated by the piezoelectric vibration plate 12 are not sufficiently transmitted to the exterior of the housing 90, and a satisfactory effect cannot be obtained.

More specifically, when the width W of the sound guide path is changed to W=(¼)φ, W=(½)φ and W=φ in the direction indicated by an arrow F1 in FIG. 1A, sound pressure versus frequency characteristics are changed as shown in FIG. 3. In FIG. 3, the horizontal axis represents frequency [kHz], and the vertical axis represents sound pressure [dB]. As seen from FIG. 3, at the narrower width W of the sound guide path, the sound pressure is reduced in the lower frequency side and a characteristic only in the higher frequency side is emphasized. Considering that the frequency characteristic is desired as flat as possible, satisfactory sound quality cannot be obtained if the width W of the sound guide path is too narrow.

Assuming here that average sound pressure within the practical band, shown in FIG. 3, is A [dB] and sound pressure at resonance frequency is B [dB], the relationship between the sound pressure difference D=(B−A) [dB] and the width W of the sound guide path is expressed as shown in the graph of FIG. 4. Also, Table 1, given below, shows correlation among the sound pressure difference D, sound energy, and sound perception.

TABLE 1

| Sound | | Sound | | |
|---|---|---|---|---|
| pressure | Sound | pressure | Sound | |
| difference | energy | difference | energy | |
| (dB) | (time) | (dB) | (times) | Perception |
| −3 | ½ | 3 | 2 | slightly percept difference |
| −5 | ⅓ | 5 | 3 | clearly percept difference |
| −10 | 1/10 | 10 | 10 | feel difference to be twice |
| −20 | 1/100 | 20 | 100 | percept much difference |

As seen from Table 1, a sound pressure level at which the difference is perceptible in the acoustic sense is generally regarded to be 3 dB or more. Therefore, a satisfactory sound pressure characteristic range can be given by −3<sound pressure difference D<+3 [dB], and a required range of the sound guide path width W can be defined correspondingly. A maximum width W_{MAX} and a minimum width W_{MIN} are determined based on many measurement results and are substantially given as follows:
maximum width W_{MAX}=diameter φ of the piezoelectric vibration plate 12 Equation 1
minimum width W_{MIN}=(½)φ Equation 2

Accordingly, good sound pressure characteristics can be obtained by setting the width W of the sound guide path to satisfy the relationship of (½)φ≦W≦φ.

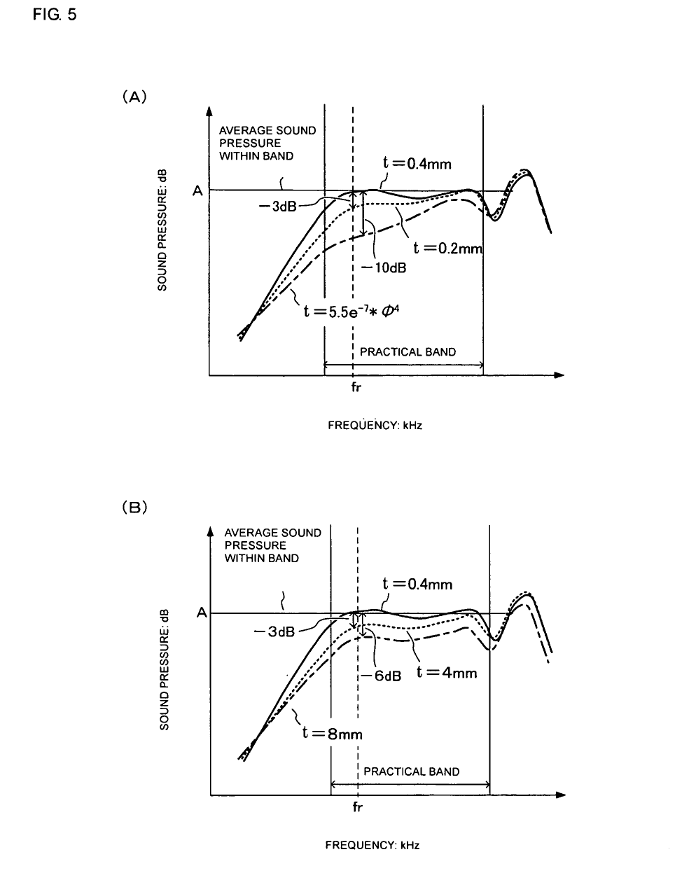

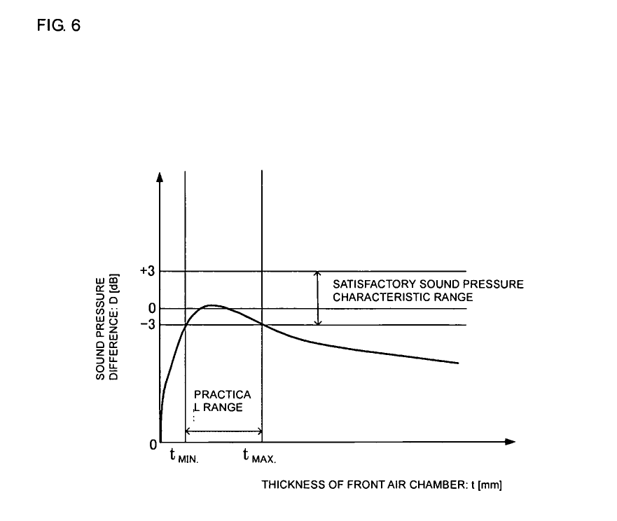

The thickness t of a front air chamber (see FIG. 1C) formed between the principal surface 92 of the housing 90 and the piezoelectric vibration plate 12 will be described below with reference to FIGS. 5 and 6. The thickness of the front air chamber as used herein corresponds to the thickness of the acoustic space forming member 60. FIGS. 5A and 5B are each a graph showing sound pressure versus frequency characteristics when the thickness t of the front air chamber of the sound generator module 10 is changed in this embodiment. FIG. 6 is a graph showing the relationship between the thickness t of the front air chamber and the sound pressure difference between average sound pressure and sound pressure at resonance frequency within the practical band.

First, as shown in FIG. 5A, it is confirmed from the results obtained by setting the thickness t of the front air chamber to t=5.5e⁻⁷φ⁴ (amplitude of the piezoelectric vibration plate 12), t=0.2 mm, and t=0.4 mm that, when the thickness t of the front air chamber is equal to or smaller than 0.2 mm, the sound pressure on the lower frequency side is reduced due to contact of the piezoelectric vibration plate 12 and air resistance. Also, as shown in FIG. 5B, from the results obtained by setting the thickness t of the front air chamber to t=0.4 mm, t=4 mm and t=8 mm, it is confirmed that overall sound pressure is reduced when the thickness t is equal to or larger than 4 mm.

Assuming here that average sound pressure within the practical band, shown in FIG. 5, is A [dB] and sound pressure at resonance frequency is B [dB], the relationship between the sound pressure difference D=(B−A) [dB] with respect to the average sound pressure A and the thickness t of the front air chamber is expressed as shown in the graph of FIG. 6. Because a satisfactory sound pressure characteristic range is given by −3<sound pressure difference D<+3 [dB] as seen from Table 1, a required range of the front air chamber thickness t can be defined correspondingly. A maximum thickness t_{MAX} and a minimum thickness t_{MIN} of the front air chamber are determined based on many measurement results and are substantially given as follows:
maximum thickness t_{MAX} of the front air chamber=4 mm Equation 3
minimum thickness t_{MIN} of the front air chamber=0.2 mm Equation 4

Accordingly, by setting the thickness t of the front air chamber to fall between 0.2 mm and 4 mm, i.e., to satisfy the relationship of 0.2 mm≦t≦4 mm, the average sound pressure can be increased and the sound pressure can be flattened, thus resulting in good sound pressure characteristics. Additionally, the width of the front air chamber is set equal to the diameter φ of the piezoelectric vibration plate 12. If the width of the front air chamber is smaller than the diameter φ of the piezoelectric vibration plate 12, it is difficult to obtain the desired characteristics. When the width of the front air chamber is larger than the diameter φ of the piezoelectric vibration plate 12, the obtained characteristics are the same as those when the width of the front air chamber is equal to the diameter φ of the piezoelectric vibration plate 12.

More specifically, assuming the thickness of the front air chamber to be t and the diameter of the piezoelectric vibration plate 12 to be φ, the amplitude of the piezoelectric vibration plate 12 is approximately expressed by 5.5e⁻⁷×φ⁴. In the case of 0<t<5.5e⁻⁷×φ⁴, therefore, when the piezoelectric vibration plate 12 is vibrated, it contacts with the principal surface 92 of the housing 90 on the inner side, whereby the sound pressure is reduced. Also, in the case of 5.5e⁻⁷×φ⁴<t<0.2 mm, even with the vibration of the piezoelectric vibration plate 12, the sounds are not sufficiently transmitted to the side surface 94 of the housing 90 because of the front air chamber being too narrow, whereby the sound pressure is reduced. Further, in the case of 4 mm<t, the piezoelectric vibration plate 12 is positioned far away from the sound guide path 66, whereby the overall sound pressure is reduced. Thus, when 0.2 mm≦t≦4 mm is satisfied, the generated sounds from the piezoelectric vibration plate 12 are sufficiently outputted to the side surface 94 of the housing 90 and a flat characteristic is obtained. For example, when the piezoelectric vibration plate 12 has the diameter φ=20 mm, its amplitude is 0.088 mm. In that case, good sound pressure characteristics can be obtained by setting the thickness t of the front air chamber to fall within the above-mentioned range.

The first embodiment constituted as described above has, among others, the following advantages.

(1) Since the holding member 50 for holding the piezoelectric vibration plate 12 and the acoustic space forming member 60 including the acoustic space 62 for the piezoelectric vibration plate 12 are each in the form of a film and they are bonded to each other, the thickness of the sound generator module 10 can be reduced. Also, since those members are easily subjected to work, a production process is facilitated.

(2) Since the acoustic space 62 is provided in the sound generator module 10, the sound pressure characteristics can be ensured by the sound generator module. Also, since there is no need of setting the acoustic space on the housing 90 side, the sound generator module 10 can be mounted alone to the housing 90, etc. As a result, an improvement of mountability and a thickness reduction can be realized.

(3) Since the holding member 50 and the acoustic space forming member 60 are bonded to each other by the adhesive tape 56 and the acoustic space forming member 60 and the housing 90 are bonded to each other by the adhesive tape 68, assembly of the sound generator module 10 and its mounting to the housing 90 are facilitated.

(4) Since the electrodes can be led out from one surface of the vibration plate 14 of the piezoelectric vibration plate 12, the presence of the electrode leading-out region does not impede realization of the thickness reduction.

(5) Since the holding member 50 and the acoustic space forming member 60 are formed of a common resin film, the cost can be cut correspondingly.

(6) By setting the diameter φ of the piezoelectric vibration plate 12 and the width W of the sound guide path 66 to satisfy (½)φ≦W≦φ and setting the thickness t of the front air chamber formed between the piezoelectric vibration plate 12 and the housing 90 to satisfy 0.2 mm≦t≦4 mm, good sound pressure characteristics can be obtained.

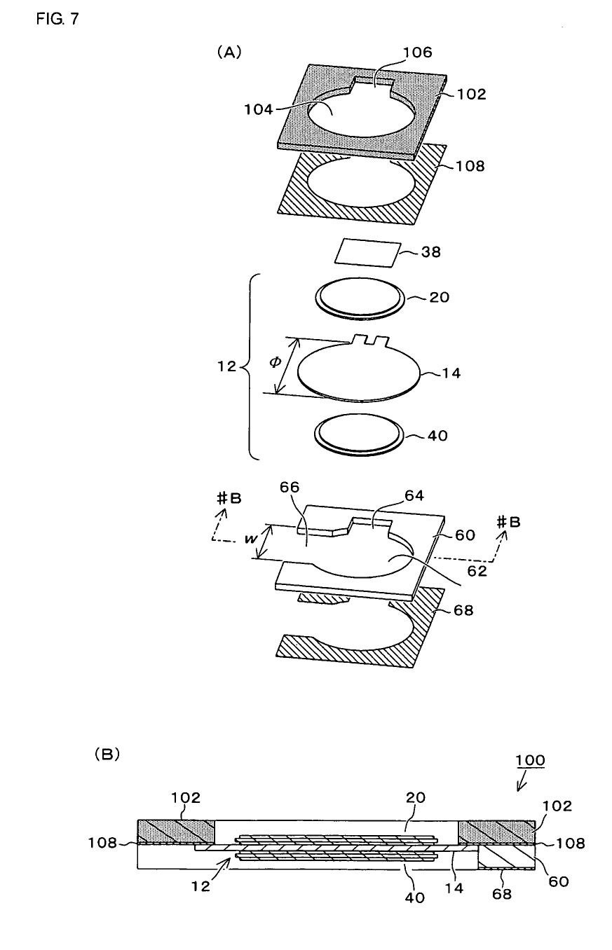

A second embodiment of the present invention will be described below with reference to FIGS. 7A and 7B. Note that the same components as or corresponding to those in the first embodiment are denoted by the same characters (this is similarly applied to other embodiments described later). FIG. 7A is an exploded perspective view of a sound generator module of this embodiment, and FIG. 7B is a sectional view taken along the line #B-#B in FIG. 7A and viewed in the direction of arrows, the view showing the sound generator module in an assembled state. While the first embodiment described above employs a common material to form the holding member 50 and the acoustic space forming member 60 and is suitable for the case of the housing 90 being hard and smooth, the holding member 50 and the acoustic space forming member 60 are formed using different materials in this second embodiment.

A sound generator module 100 of this second embodiment has a basic structure similar to that of the first embodiment except for that a holding member 102 for holding the piezoelectric vibration plate 12 is formed of a film having a yielding property, such as PORON. As with the holding member 50 in the first embodiment, the holding member 102 has a window 104 and a lead-out portion 106 formed therein, and an adhesive tape 108 is attached to the back surface of the holding member 102. By utilizing the yielding film to form the holding member 102, it is possible to absorb minute irregularities and dimensional errors. Therefore, close contact with a housing, etc. can be ensured just by pressing the sound generator module against it with no need of separately preparing another yielding material. The other operation and advantages of this second embodiment are basically the same as those in the first embodiment. While the holding member 102 is made of the yielding material in this second embodiment, the acoustic space forming member 60 may be made of the yielding material as required.

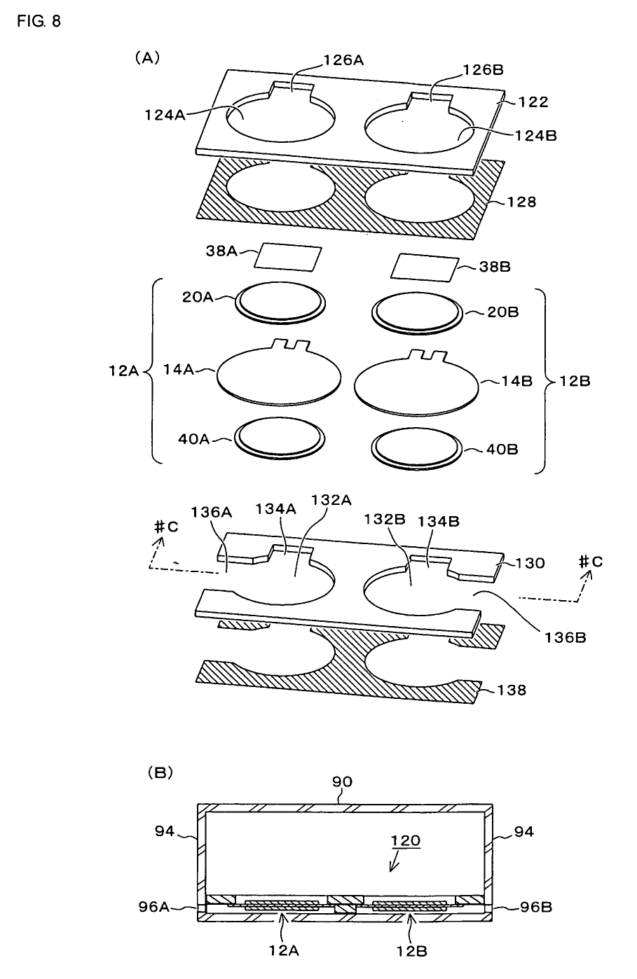

A third embodiment of the present invention will be described below with reference to FIGS. 8A and 8B. FIG. 8A is an exploded perspective view of a sound generator module of this embodiment, and FIG. 8B is a sectional view taken along the line #C-#C in FIG. 8A and viewed in the direction of arrows, the view showing one example of mounting of the sound generator module. While one sound generator module includes one piezoelectric vibration plate in the above-described first and second embodiments, one sound generator module includes two piezoelectric vibration plates in this third embodiment. A sound generator module 120 of this third embodiment is constituted by two piezoelectric vibration plates 12A and 12B, a holding member 122, and an acoustic space forming member 130, the latter two being common to the piezoelectric vibration plates 12A and 12B.

Each of the piezoelectric vibration plates 12A and 12B has the same structure as the piezoelectric vibration plate 12 in the first embodiment. More specifically, the piezoelectric vibration plate 12A includes piezoelectric elements 20A and 40A on the front and back sides of a vibration plate 14A, and the piezoelectric vibration plate 12B includes piezoelectric elements 20B and 40B on the front and back sides of a vibration plate 14B. Electrodes are led out from the piezoelectric vibration plates 12A and 12B through electrical connecting portions 38A and 38B. Further, the holding member 122 has windows 124A and 124B and lead-out portions 126A and 126B which correspond respectively to the piezoelectric vibration plates 12A and 12B, and an adhesive tape 128 is attached to the back surface of the holding member 122. The acoustic space forming member 130 has acoustic spaces 132A and 132B, lead-out portions 134A and 134B, and sound guide paths 136A and 136B which correspond respectively to the piezoelectric vibration plates 12A and 12B. The sound guide paths 136A and 136B are formed to reach opposed edges of the acoustic space forming member 130, respectively. The holding member 122 and the acoustic space forming member 130 are each formed of, e.g., a resin film.

On the other hand, the housing 90 in which is mounted the sound generator module 120 of this embodiment has sound output holes 96A and 96B formed in a pair of side surfaces 94 of the housing 90. In the sound generator module 120, one sound guide path 136A is communicated with one sound output hole 96A, and the other sound guide path 136B is communicated with the other sound output hole 96B. The structure of this embodiment is suitable, by way of example, for the case where 2-channel sounds are reproduced in a stereophonic system, etc. The basic operation and advantages of this third embodiment are similar to those of the above-described embodiments.

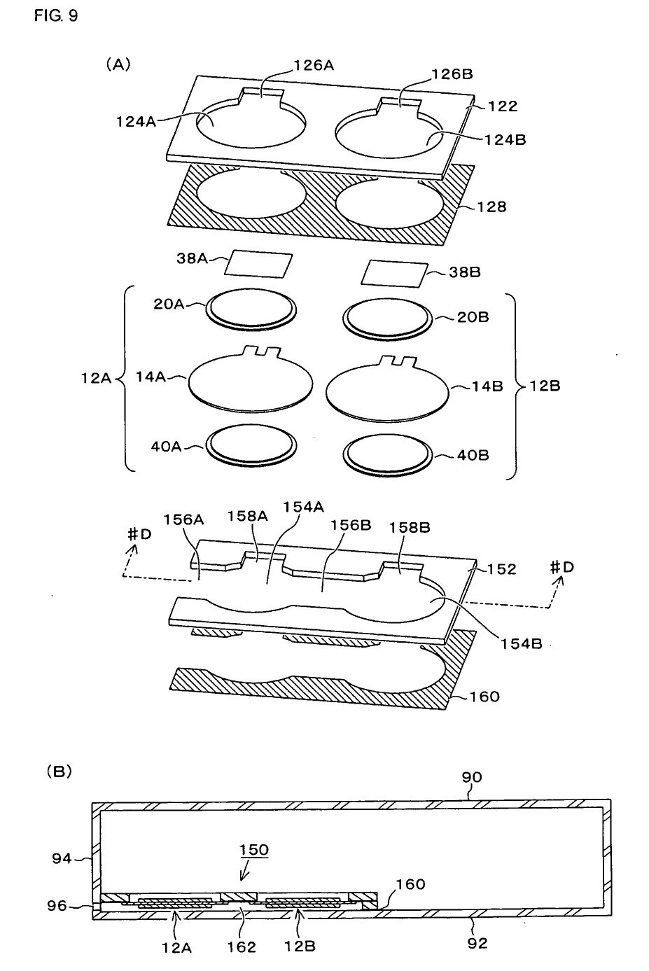

A fourth embodiment of the present invention will be described below with reference to FIGS. 9A and 9B. FIG. 9A is an exploded perspective view of a sound generator module of this embodiment, and FIG. 9B is a sectional view taken along the line #D-#D in FIG. 9A and viewed in the direction of arrows, the view showing one example of mounting of the sound generator module. As in the above-described third embodiment, one sound generator module includes two piezoelectric vibration plates in this fourth embodiment. In a sound generator module 150 of this fourth embodiment, an acoustic space forming member 152 has acoustic spaces 154A and 154B, lead-out portions 158A and 158B, and sound guide paths 156A and 156B which correspond respectively to the piezoelectric vibration plates 12A and 12B. Further, the sound guide path 156B and the acoustic space 154A are in continuity with each other to form a serially continued acoustic space 162 (see FIG. 9B) such that sounds are outputted through a sound output hole 96 formed in one side surface 94 of the housing 90. The piezoelectric vibration plates 12A and 12B and the holding member 122 in this fourth embodiment have the same structures as those in the third embodiment. According to this fourth embodiment, because sounds generated from the two piezoelectric vibration plates 12A and 12B are outputted through one sound output hole 96, the sound pressure can be increased in addition to the above-described advantages of the first embodiment.

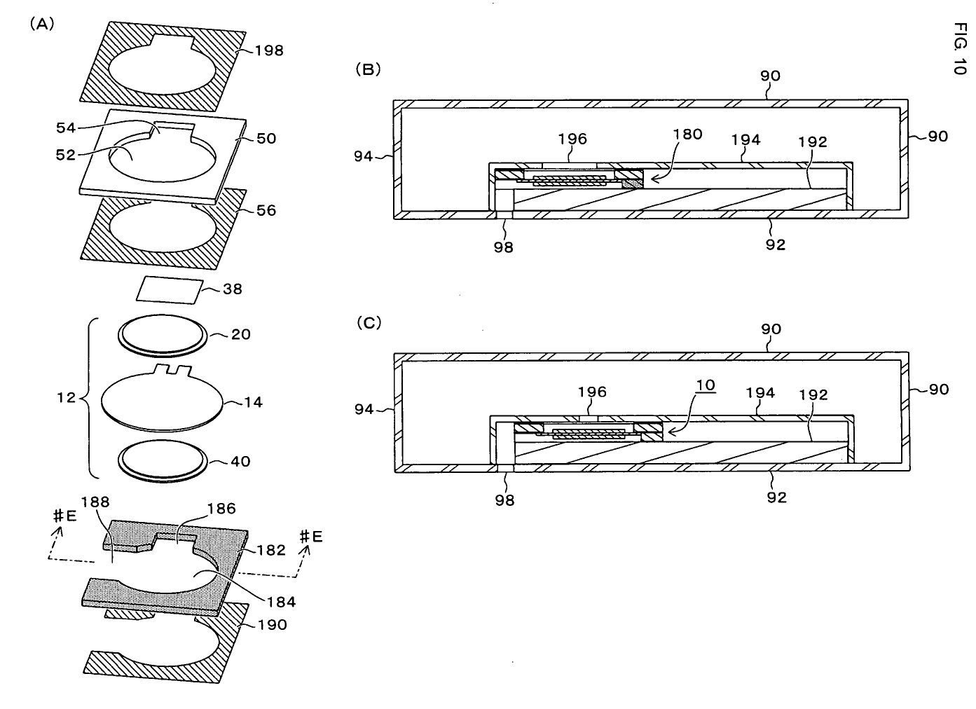

A fifth embodiment of the present invention will be described below with reference to FIGS. 10A-10C. FIG. 10A is an exploded perspective view of a sound generator module of this embodiment, and FIG. 10B is a sectional view taken along the line #E-#E in FIG. 10A and viewed in the direction of arrows, the view showing one example of mounting of the sound generator module. FIG. 10C is a sectional view showing a modification of the fifth embodiment. While in any of the above-described first to fourth embodiments the sound generator module is directly mounted to the inner surface of the housing 90, this fifth embodiment is constituted such that the sound generator module is mounted to an electronic component which is contained in the housing of the electronic device. In this fifth embodiment, a liquid crystal display is contained as the electronic component in the housing. In a sound generator module 180 of this fifth embodiment, an acoustic space forming member 182 is formed of a yielding film, such as POLON, whereas the piezoelectric vibration plate 12 and the holding member 50 have the same basic structures as those in the first embodiment. Additionally, an adhesive tape 198 is bonded to the upper surface of the holding member 50. The acoustic space forming member 182 has an acoustic space 184, a lead-out portion 186, and a sound guide path 188, and an adhesive tape 190 is attached to the back surface of the acoustic space forming member 182.

The liquid crystal display is constituted by a liquid crystal (liquid crystal unit) 192 including a backlight, a front cover (not shown), a back cover 194, and so on, those covers housing the liquid crystal 192. A vent hole 196 is formed in the back cover 194. Further, in this fifth embodiment, a sound output hole 98 is formed in a bottom surface 92 of the housing 90. The sound generator module 180 is mounted to be positioned between the inner surface of the back cover 194 and the back surface of the liquid crystal 192 by using the adhesive tapes 190 and 198. In the illustrated example, the sound generator module 180 is mounted to slightly project out of the edge of the liquid crystal 192 such that sounds are outputted to the exterior through the sound output hole 98 formed in the bottom surface 92 of the housing 90. By using the sound generator module as in this embodiment, the sound generator module can also be easily mounted to, e.g., the electronic component in the housing. Incidentally, as shown in FIG. 10C, the sound generator module 10 of the first embodiment may be mounted between the liquid crystal 192 and the back cover 194 without using the yielding film.

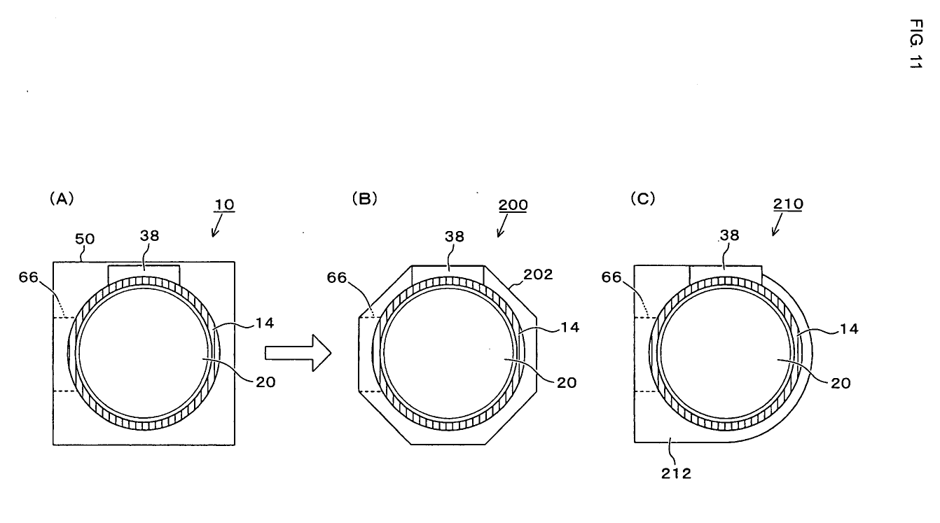

A sixth embodiment of the present invention will be described below with reference to FIGS. 11A-11C. FIG. 11A is a plan view of the sound generator module of the first embodiment, and FIGS. 11B and 11C are each a plan view of the sound generator module of the sixth embodiment. While in any of the above-described first to fifth embodiments, as typically shown in FIG. 11A, the sound generator module 10 has a substantially square shape as a whole, this sixth embodiment employs the sound generator module having a shape other than the square. A sound generator module 200 shown in FIG. 11B represents the case where a holding member 202 and an acoustic space forming member (not shown) have a substantially octagonal shape, and a sound generator module 210 shown in FIG. 11C represents the case where respective parts of a holding member 212 and an acoustic space forming member (not shown) are formed into a substantially semicircular shape along the edge of the piezoelectric element 20. By chamfering peripheral corners of the sound generator module or forming the outer periphery thereof into a curved shape, a space can be more effectively utilized in points of, for example, mounting other components and ensuring a ventilation gap on the backside.

The present invention is not limited to the above-described embodiments and can be modified in various ways without departing from the gist of the invention. For example, modifications may be made as follows:

(1) The materials, the shapes and the dimensions are described, by way of example, in the embodiments, and they can be appropriately modified as a matter of design choice.

(2) Each of the piezoelectric vibration plates 12, 12A and 12B may be of a unimorph or bimorph structure. The laminated structure of the piezoelectric element, the connection pattern of the inner electrodes, the lead-out structure, etc. can also be appropriately modified as required.

(3) The electrode leading-out structure described above in the first embodiment is merely one example, and it may be constructed as shown in FIG. 2B. A piezoelectric vibration plate 70, shown in FIG. 2B, has a bimorph structure in which piezoelectric elements 74 and 76 are bonded respectively to the front and back sides of a circular vibration plate 72 which is made of a metal, e.g., stainless steel. The piezoelectric elements 74 and 76 are formed respectively by forming electrode layers 74B and 74C; 76B and 76C made of Ni, Pd or Ag, for example, on the front and back sides of piezoelectric layers 74A and 76A which are made of a piezoelectric ceramic, e.g., lead zirconate titanate (PZT). The electrode layers 74B and 76C are led out to the exterior by conductor patterns 78A and 78B, whereas the electrode layers 74C and 76B and the vibration plate 72 are led out to the exterior by a conductor pattern 82. Insulating films 80A and 80B are interposed between the conductor patterns 78A, 78B and the vibration plate 72. The piezoelectric vibration plate 70 having such a structure can also be employed by bonding it to the holding member 50 together with the acoustic space forming member 60 as in the first embodiment.

(4) The housing 90 and the back cover 194 are also described, by way of example, in the above embodiments. The sound generator module can be mounted to any structural member that is used to fix, protect, or seal-off a component disposed inside an electronic device, without being necessarily limited to a component positioned on the outermost side.

(5) The liquid crystal display described in the above embodiment is merely one example, and the sound generator module may be integrally mounted to a battery case or another case for fixing an electronic component.

6) The piezoelectric vibration plate may be attached to the holding member and the acoustic space forming member by any suitable method such as bonding and pressing. This point is similarly applied to attachment of the sound generator module to the housing and the electronic component.

(7) Preferred application examples include various kinds of electronic devices, such as a cellular phone, a personal digital assistant (PDA), a voice recorder, a PC (personal computer), and a digital audio unit.

According to certain embodiments, the holding member for holding the piezoelectric vibration plate and the acoustic space forming member for forming the acoustic space for the piezoelectric vibration plate are each in the form of a film, and they are bonded to each other to constitute the sound generator module, thus obtaining good sound pressure characteristics. Therefore, these embodiments can be applied to applications requiring a thin sound generator module. In particular, they can be suitably practiced in providing sound generator modules mounted in light-weight and small electronic devices, such as a cellular phone.

The foregoing description details certain embodiments of the invention. It will be appreciated, however, that no matter how detailed the foregoing appears in text, the invention may be practiced in many ways. It should be noted that the use of particular terminology when describing certain features or aspects of the invention should not be taken to imply that the terminology is being re-defined herein to be restricted to including any specific characteristics of the features or aspects of the invention with which that terminology is associated.

While the above detailed description has shown, described, and pointed out novel features of the invention as applied to various embodiments, it will be understood that various omissions, substitutions, and changes in the form and details of the device or process illustrated may be made by those skilled in the technology without departing from the spirit of the invention. The scope of the invention is indicated by the appended claims rather than by the foregoing description. All changes which come within the meaning and range of equivalency of the claims are to be embraced within their scope.

What is claimed is:

1. A sound generator module comprising:
a piezoelectric vibration plate comprising a piezoelectric element on a principal surface of a vibration plate;
a holding member configured to hold said piezoelectric vibration plate; and
an acoustic space forming member configured to form an acoustic space for said piezoelectric element,
wherein said holding member and said acoustic space forming member are bonded to each other.

2. The sound generator module according to claim 1, wherein said acoustic space forming member comprises at least one sound guide path in continuity with said acoustic space.

3. The sound generator module according to claim 2, wherein, a width of said sound guide path W and a diameter of said piezoelectric vibration plate φ satisfy the relationship of (½)φ≦W≦φ.

4. The sound generator module according to claim 1, a thickness of said acoustic space forming member t is approximately in the range of 0.2 mm to 4.0 mm.

5. The sound generator module according to claim 1, wherein said holding member and said acoustic space forming member are made of substantially the same material.

6. The sound generator module according to claim 1, wherein at least one of said holding member and said acoustic space forming member comprises a resin film.

7. The sound generator module according to claim 6, wherein said resin film is made of polyethylene terephthalate.

8. The sound generator module according to claim 1, wherein at least one of said holding member and said acoustic space forming member comprises a yielding film.

9. The sound generator module according to claim 1, wherein a plurality of piezoelectric vibration plates are arranged corresponding to a pair of said holding member and said acoustic space forming member.

10. A sound generating structure comprising the sound generator module according to claim 1, wherein a sound output hole is formed in a housing to which is directly or indirectly mounted said sound generator module.

11. An electronic device comprising the sound generator module according to claim 1.

12. The sound generator module according to claim 1, wherein said holding member and said acoustic space forming member are bonded to each other by an adhesive tape.

13. The sound generator module according to claim 1, wherein said holding member and said acoustic space forming member are formed of a common resin film.

14. The sound generator module according to claim 1, wherein the piezoelectric vibration plate further comprises one or more electrodes let out from one surface of the vibration plate.
